(19) United States
(12) Patent Application Publication
(10) Pub. No.: US 2003/0145697 A1
(43) Pub. Date: Aug. 7, 2003

(54) Die cutting system, components thereof, and methods

(76) Inventors: Natasha P. Hixon, Provo, UT (US); Mark A. Hixon, Provo, UT (US)

Correspondence Address: TRASK BRITT, P.O. BOX 2550, SALT LAKE CITY, UT, 84110, US

(21) Appl. No.: 09/864,723

(22) Filed: May 23, 2001

(51) Int. Cl. B26D 1/00

(52) U.S. Cl. 83/13; 83/531

(57) ABSTRACT

A die cutting system that includes a press and a substantially planar die with a plate and at least one cutting edge protruding from a surface of the plate. The press is manually operated and may be hand-held or supported upon a flat surface, such as a tabletop. A first member of the press receives the substantially planar die, while a second member of the press provides support for a sheet of material from which the die will cut a pattern upon biasing the die against the sheet of material. Manually operated presses and die cutting methods that employ teachings of the invention are also disclosed.

### BACKGROUND OF THE INVENTION

1. Field of the Invention

The present invention relates generally to die cutters and die cutting systems for use with sheets of paper, card stock, plastic, fabric, metal (i.e., foil), and the like. More specifically, to die cutting systems which include compact dies. The present invention also relates to hand-held die cutters.

2. Background of the Related Art

Die cutters have long been used to cut specific shapes from sheets of paper, card stock, and other materials, such as plastic, fabric, metal, and the like. Nonetheless, conventional die cutters are large, expensive machines and, as a result, their availability to individuals has been limited.

An exemplary type of industrial die cutting device includes a thin planar plate member from which a die cutting edge protrudes. The plate member of such a device is typically somewhat flexible to facilitate the assembly thereof with a cylindrical drum which, when rotated, repeatedly cuts the same pattern into a sheet of material. Such an industrial die cutting device may be used, for example, to form windows in envelopes and food packages (e.g., the lids of cylindrical ice cream containers, cookie package windows, etc.). The practical use of such die cutting devices is limited to large-scale commercial production.

Die cutting kits or systems have been made available which include a press and several different dies that may be used with the press. Each die typically comprises a steel rule or cookie-cutter type die that has been formed into a desired shape from a ribbon or strip of metal with a sharpened lower edge. These dies have members that are engaged by the press associated therewith to force the die against and through one or more pieces of paper or card stock to form the desired image therefrom. A spring or other resilient member may also be associated with such dies to facilitate removal thereof from the paper or card stock. In addition, a resilient member, such as a piece of foam rubber, positioned centrally within the die prevents the cut paper or card stock from becoming trapped within the confines of the die. Thus, each such die is part of a somewhat complex die cutting device and, as a result, may be undesirably large. The table-top presses of such die cutting kits or systems are also relatively large. In fact, due to the sizes of these presses and die cutting devices, a briefcase or suitcase sized container is required to store a press and an alphabet sized set (i.e., 26) of die cutting devices.

Further, steel rule dies are formed by bending one or more ribbons or strips of metal into the desired shape. Consequently, the size of image that can be formed with the ribbon or strip of metal is size-limited to a degree that depends upon the thickness of the metal ribbon or strip, as well as on the capabilities of a die forming apparatus. By way of example, conventional steel rule dies typically cannot be used to form letters of the alphabet having a height of less than about one and a quarter (1¼) inches.

At the opposite end of the spectrum, paper punches are relatively inexpensive devices that have long been available to individuals. Paper punches are noncomplex devices that operate on the principle that a male member, which is disposed on one side of a sheet of material, and a female member, which is positioned on the opposite side of the sheet of material, may be biased against one another and against the sheet of material to form a pattern from the sheet. The shapes that may be formed with conventional paper punches are similarly noncomplex, making them somewhat undesirable for use in decorative applications, such as in scrap booking and creating displays. Moreover, the cuttings formed by paper punches are often undesirably small for use in applications, such as on posters, bulletin boards, or other displays, where visibility from a distance is desired.

As a consequence of the unavailability of conventional die cutting apparatus and the noncomplexity and small sizes of cutting formed by paper punches, individuals who wanted to use letters of the alphabet or other images formed from paper, card stock, or sheets of other materials often had to cut these images by hand.

Recently, punch cut systems which are similar to the above-described die cutting systems, but are intended more for individual consumers have been developed. One type of punch cut system includes a punch with cooperating male and female members. The punch of this type of system is assembled (e.g., screwed into a receptacle of) with a small hand-operated, tabletop press. Examples of this type of system are disclosed in U.S. Pat. No. 5,601,006 to Quinn et al., U.S. Pat. No. 6,000,139 to Chan, and U.S. Pat. No. 6,089,137 to Lee. Downward (i.e., toward the table) force is applied to a handle of the press to bias the male and female members toward one another and against opposite sides of a sheet of paper to form the desired pattern therefrom. Upward (i.e., away from the table) force is applied to the handle (either manually or by way of a spring or similar mechanism) to remove the male member of the punch from the sheet and to facilitate removal of the formed pattern from the punch and press.

Smaller, individual, thumb-operated punches that include cooperating male and female members that are simultaneously forced through a sheet of paper or card stock are also known in the art. While these hand-operated punches work in a manner similar to the punches of that of the above-described press-operated punches, they require less force to cut paper or card stock.

Nonetheless, currently available hand-operated and thumb-operated punches from which cut paper may be readily removed are typically not capable of forming images with internal holes, such as the internal holes of many letters of the alphabet (e.g., a, b, d, e, g, o, etc.). As with the previously discussed die cutting system, a relatively large amount of space would be required to store an alphabet sized set of these hand-operated punches.

Another type of punch which is configured to form images with internal holes includes a first member with an outer male punch element and an inner female punch element and a cooperating second member with an outer female punch element and an inner male punch element. The inner punch elements of this type of punch are recessed relative to the outer punch elements or vice-versa. In use of this type of punch, the outer punch elements form the outer periphery of a pattern to be cut from a sheet of material, while the inner members form the inner periphery of the pattern. As one of the outer and inner sets of cooperating punch elements is recessed relative to the other to facilitate the formation of a pattern with internal holes, however, the cut pattern typically becomes trapped within such a punch. Consequently, the members of the punch must be pulled away from one another so that the cut pattern may be removed therefrom.

Accordingly, there is a need for a more compact, easy to use die cutting system that does not require multiple dies to form a single image from paper or card stock. There is also a need for a die cutting system that forms smaller images than the currently available systems.

### SUMMARY OF THE INVENTION

The present invention includes a die cutting system for forming images from a sheet of paper, card stock, or other material, such as plastic, foil (i.e., metal), fabric, or the like. A die cutting system incorporating teachings of the present invention includes a hand-held, hand-operated press and one or more dies that may be removably assembled with the press, removed therefrom, and replaced with another die.

A die that may be used in the system of the present invention comprises a thin, substantially planar member with a flat back side and cutting edges protruding from a front side thereof The cutting edges, which protrude a relatively short distance from front side, form a design or pattern that may be reproduced, by cutting into, a sheet of paper or other material. The die may also carry an element, referred to herein as a cuttings release element or an ejection element, that prevents die cuttings from becoming trapped within the confines of the cutting edges. The material from which the die is formed preferably facilitates repeated use of the die to cut the design or pattern into paper or another material. By way of example only, the die may be formed from a metal such as steel.

An exemplary hand-held, hand-operated press embodying teachings of the present invention includes two opposed, substantially planar members that may be moved toward one another and biased against each other, as well as pulled apart from one another. A first of the opposed members is configured to receive and retain a die in such a manner that the die may be used to cut a design into a sheet of paper or other material. A second of the opposed members supports the sheet of paper or other material as the first member is being biased against the second member and the cutting edges of the die are being forced through the sheet.

A press according to the present invention may also include a biasing member that is associated with the two opposed members so as to force the opposed members toward one another. Biasing member may also be configured to pull the opposed members apart from one another once a cutting of the desired design or pattern has been cut from a sheet of paper or other material. In an exemplary embodiment, an actuation member includes two handles that are configured and associated with one another in a similar manner to the handles of pliers. The handles of such an embodiment are pivotally connected to one another such that by moving or squeezing the handles together, the first and second opposed members are forced toward one another, whereas the first and second members are forced apart from each other when the handles are pulled away from one another.

The die cutting system of the present invention is particularly useful for individual use in decorating photo albums (i.e., scrapbooking), as well as in for use in displays (e.g., on poster boards, bulletin boards, and the like) and in other applications.

Other features and advantages of the present invention will become apparent to those of ordinary skill in the art through consideration of the ensuing description, the accompanying drawings, and the appended claims.

### BRIEF DESCRIPTION OF THE DRAWINGS

In the drawings, which illustrate exemplary embodiments of the present invention:

FIG. 1 is a front view of a die that may be coupled to and used with the press according to the present invention;

FIG. 2 is a cross-sectional view taken along line 2-2 of FIG. 1;

FIG. 3 is side view of an exemplary embodiment of a press of a die cutting system according to the present invention;

FIGS. 3A-3C are partial side views illustrating variations of a first, die receiving member of the press of FIG. 3;

FIG. 4 is a side view that illustrates assembly of the die of FIGS. 1 and 2 to the press of FIG. 3;

FIGS. 5-7 are side views depicting use of the assembly of FIG. 4 to cut a design from a sheet of paper or other material;

FIG. 8 is a side view of another exemplary embodiment of a press of a die cutting system of the present invention;

FIG. 9 is a side view of a cradle which supports the press of FIG. 8 upon a flat surface during use of the press; and

FIG. 10 is a perspective view of yet another embodiment of press incorporating teachings of the present invention.

### DETAILED DESCRIPTION OF THE INVENTION

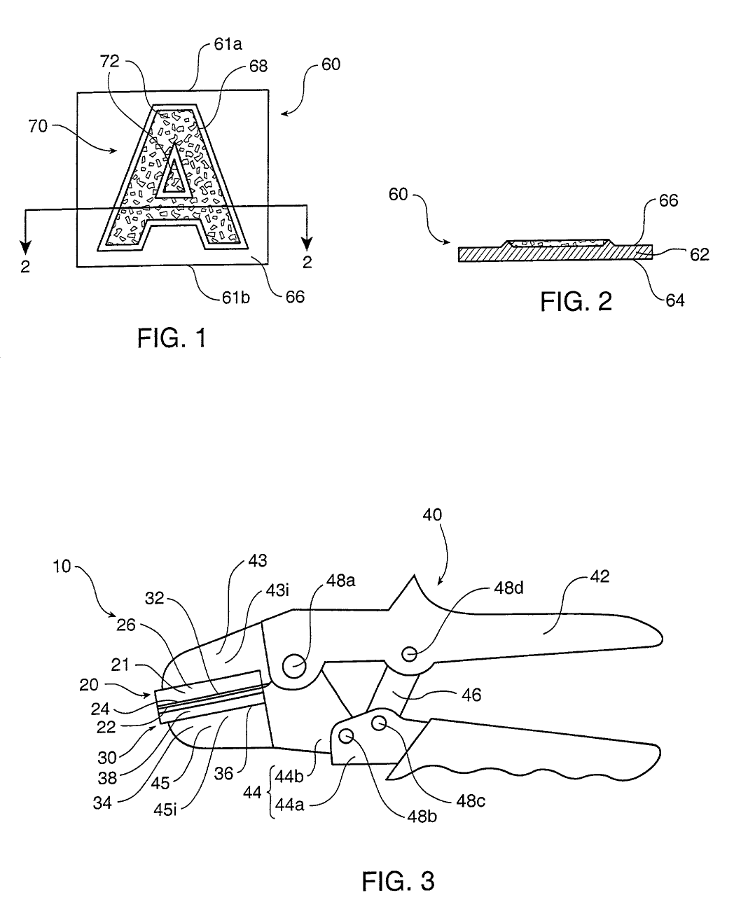

With reference to FIGS. 1 and 2, a die 60 is illustrated that embodies teachings of the present invention. Die 60 includes a thin, unitary, substantially planar plate 62 with a flat back side 64 and a cutting edge 68 protruding a short distance from a front side 66 thereof. Cutting edge 68 forms a design or pattern 70 to be cut into a sheet of paper or other material.

The lateral dimensions of cutting edge 68, as well as the material from which cutting edge 68 is formed, preferably impart cutting edge 68 with the ability to withstand repeated use while minimizing the amount of pressure required for cut into a sheet of paper, card stock or other material. The heights of cutting edges 68 are sufficient to cut through sheets of one or more types of material and thicknesses. By way of example only, a 0.015 inch cutting edge 68 height should be sufficient for cutting through most types of card stock, which typically have thicknesses in the range of about 0.010 inch to about 0.015 inch. In addition, the amount of wear that is endured by both cutting edges 68 and a die supporting member against which cutting edges 68 are forced during use of die 60 should also be taken into consideration when determining an optimal cutting edge 68 height.

Likewise, the material and thickness of the remainder of die 60 preferably impart die 60 with desired attributes, such as strength to withstand the force or pressure applied thereto in use and durability to withstand repeated use. Because the pressure applied to die 60 will be localized at cutting edges 68 thereof during use, the thickness and material of the remaining portions of plate 62 are preferably sufficient to impart die 60 with desired amounts of strength and durability.

Die 60 may also include one or more ejection elements 72, which facilitate removal of cuttings that have been formed by die 60 from a sheet of paper, card stock, or another material from locations between adjacent cutting edges 68. By way of example only, ejection element 72 may include a thin sheet of a compressible, resilient material (e.g. foam rubber) that has a thickness that, in its relaxed state, is sufficient to force cuttings from between adjacent cutting edges 68.

Cutting edge 68 may be formed by known processes. By way of example only and not to limit the scope of the present invention, chemical mask and etch processes may be employed to form one or more cutting edges 68 on a die plate 62, such as a thin sheet (e.g., 30 mils or 0.030 inch thick) of spring steel. A mask may be formed over the locations of front side 66 of plate 62 at which cutting edges 68 are to be located. When a chemical or mixture of chemicals that etches plate 62 is used to form cutting edges 68, the mask may be formed from a material, such as a suitable photoresist, that will withstand exposure to the etchant chemical or chemicals.

When a photoresist is used as the mask material, a layer of the photoresist may be formed on a surface (e.g., front side 66) of plate 62 and patterned, or exposed and developed, by known photochemical machining processes. Regions of the surface of plate 62 that are exposed through the photomask may then be exposed to a suitable etchant (i.e., an aqueous solution of ferric chloride) to remove material of plate 62 through the photomask and to thereby form cutting edges 68. Plate 62 is exposed to the etchant for a duration of time that is appropriate for forming cutting edges 68 that protrude a desired distance from a front side of plate 62. The remaining portions of plate 62 are preferably thick enough to impart plate 62 with the desired structural properties (e.g., strength, rigidity, etc.). Thereafter, the etchant is washed or otherwise removed from plate 62 to ensure that no further etching of plate 62 occurs. The photomask may then be removed from the formed die 60 and any desired additional processes may be conducted, such as teflon-coating of die 60, planarizing back side 64 thereof (e.g., by grinding), or securing one or more ejection elements 72 to plate 62 within the confines of cutting edges 68.

Due to the fine dimensions that may be achieved by use of such processes, design or pattern 70 of die 60 may be smaller or more detailed than the designs or patterns of currently available paper-cutting dies.

As each die 60 is a thin, unitary member, the amount of space consumed by each die is relatively small when compared with the sizes of the currently available paper punch devices. In one embodiment, the overall thickness of a die 60, including the combined thickness of the portion of plate 62 that remains following the etching process (e.g., 0.010 inch or 10 mils) and the distance cutting edges 68 protrude therefrom (e.g., 0.020 inch or 20 mils), is about 0.030 inch, or 30 mils. Consequently, an alphabet-sized set of 2″×2″ dies 60 may be compactly and portably stored.

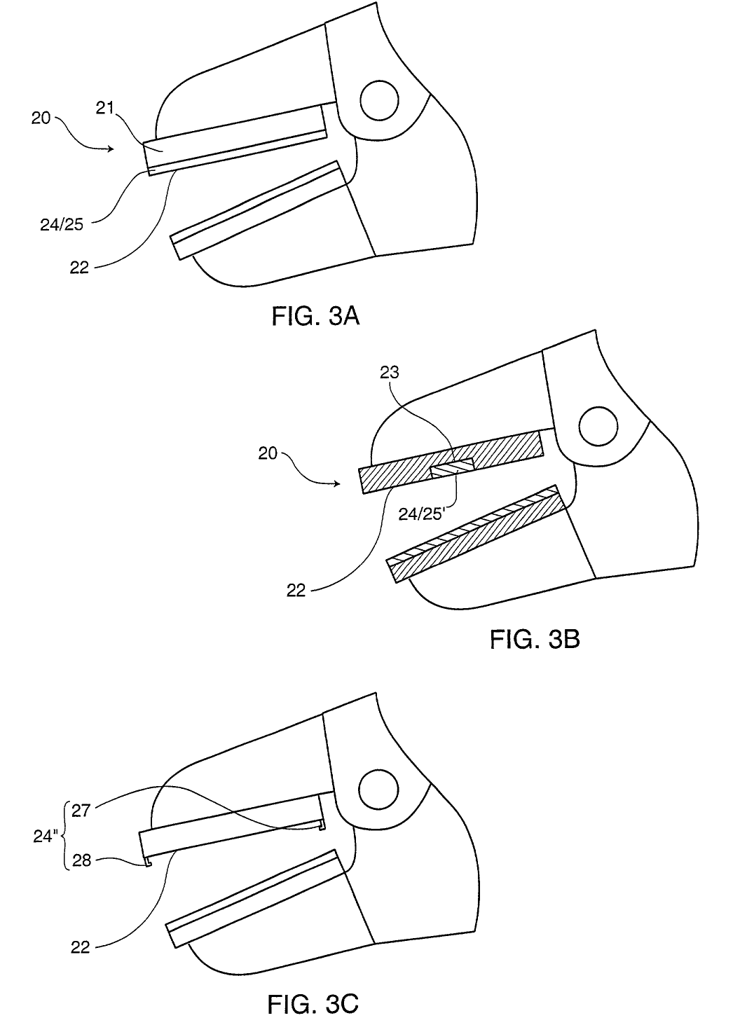

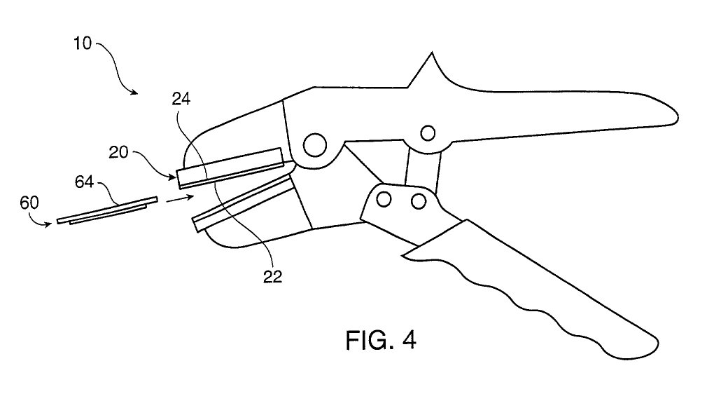

Turning now to FIGS. 3-3C, an exemplary embodiment of a press 10 according to the present invention is depicted.

As depicted in FIG. 3, press 10 is configured to bias a die 60 against a sheet of paper or other material in a somewhat radial fashion. Press 10 includes a first member 20, a second member 30 in substantially opposed orientation relative to first member 20, and a biasing element 40.

First member 20 includes a substrate 21, a substantially planar die receiving surface 22, a die retaining element 24 associated with die receiving surface 22, and a connection element 26 located opposite die receiving surface 22.

Die receiving surface 22, which is substantially planar, is configured to receive the substantially planar back side 64 of a die 60 of the invention. In use, die receiving surface 22 applies pressure to back side 64 of die 60, which pressure is then transferred to cutting edges 68 of die 60 to force the same through a sheet of paper, card stock, or another material. Accordingly, the dimensions or die receiving surface 22 are preferably adequate to provide support to the entire design or pattern 70 formed by cutting edges 68 of die 60.

As shown in FIG. 3A, a first example of a die retaining element 24 comprises a substantially planar sheet magnet 25 that is disposed substantially across substrate 21 and that forms die receiving surface 22. Die retaining element 24 is useful for securing to first member 20 dies 60 (FIGS. 1 and 2) that are formed from materials that are attracted to a magnetic field, such as various types of steel and other iron-containing materials. Upon positioning a magnetically attracted die 60 on or in proximity to die receiving surface 22, the magnetic field generated by magnet 25 draws die 60 toward die receiving surface 22 and secures die 60 on die receiving surface 22.

Alternatively, as depicted in FIG. 3B, die receiving surface 22 of first member 20 may be formed by substrate 21, which also includes a recess 23 formed therein. A disk-shaped magnet 25′ is disposed and secured within recess 23. Magnet 25′ operates by generating a magnetic field into which the material of a complementary die 60 (FIGS. 1 and 2) is drawn, thereby pulling die 60 against die receiving surface 22.

As yet another alternative, shown in FIG. 3C, a die 60 (FIGS. 1 and 2) may be secured to first member 20 by way of a die retaining element 24″ that includes an L-shaped attachment flange 27 protruding above the plane of die receiving surface 22 and extending partially thereover so as to receive at least an edge 61a of a die 60 positioned on die receiving surface 22. Die retaining element 24″ also includes a movable retention arm 28 that is configured to be positioned so as to engage at least a portion of another, opposite edge 61b of die 60 positioned on die receiving surface 22.

Other alternative types of die retaining elements that may be used on first member 20 include, but are not limited to, the use of adhesive materials or VELCRO to secure a die 60 (FIGS. 1 and 2) in positioned upon die receiving surface 22.

Referring again to FIG. 3, second member 30 of the illustrated embodiment of press 10 includes a substantially planar sheet support surface 32. Sheet support surface 32 comprises a support for a sheet of paper, card stock, or another material as a die 60 (FIGS. 1 and 2) that has been coupled to first member 20 is being used to cut a design or pattern from the sheet. As with die receiving surface 22 of first member 20, the dimensions of sheet support surface 32 of second member 30 are preferably at least as large as the corresponding dimensions of design or pattern 70 of die 60. As a result, when first and second member 20 and 30 are being biased against one another to cut a sheet of paper, card stock, or another material, cutting edges 68 may be forced through the with a substantially uniform amount of force or pressure.

As cutting edges 68 of die 60 (FIGS. 1 and 2) are biased against sheet support surface 32 with a substantial amount of pressure (e.g., as much as about 3,500 pounds per square inch of pressure), sheet support surface 32 may comprise a relatively soft material to prevent damage to or dulling of cutting edges 68. The exemplary, illustrated embodiment of second member 30 includes a rigid support structure 34 with a cushioning element 38 secured thereto that forms sheet support surface 32.

Cushioning element 38 may be formed from a substantially rigid material that will also absorb some of the force that is applied by cutting edges 68 to sheet support surface 32 as first and second members 20 and 30 are biased against one another to cut a design or pattern from a sheet of paper, card stock, or another material. By way of example only, cushioning element 38 may be formed from a polymer, such as high density polyethylene, that is softer than the material from which cutting edges 68 of die are formed. Cushioning element 38 may be secured to support structure 34 by use of a suitable adhesive material, by mechanical fasteners (e.g., nuts and bolts, edge-engaging clips, etc.) or as otherwise known.

An exemplary embodiment of biasing element 40 of press 10 may include two handles 42 and 44 which control the movement of first member 20 and second member 30 toward and away from one another. As in the embodiment shown in FIG. 3, first member 20 and second member 30 may be directly associated with corresponding handles 42 and 44, respectively. Handles 42 and 44 may be connected to one another at a single pivot point, similar to simple pliers.

Alternatively, handles may be configured to provide leverage and increase the amount of force or pressure with which first member 20 and second member 60 are biased against one another. By way of example only, the configuration of lever action pliers available from Knipex-Werk of Wuppertal, Germany (hereinafter “Knipex”), as catalog no. 97 52 14 may be employed as biasing element 40. As depicted, such a biasing element includes a single-member first handle 42, a second handle 44 with a gripping member 44a and a biasing member 44b, and a leveraging member 46 positioned intermediately between and associated with both first member 42 and second member 44. First handle 42 may be bent at a location adjacent a first member-connection head 43 thereof First handle 42 is joined to biasing member 44b of second handle 44 at a first pivot point 48a located proximate first member-connection head 43 and second member-connection head 45 of biasing member 44b of second handle 44. Biasing member 44b of second handle 44 and an end of gripping member 44a thereof are connected at a second pivot point 48b. One end of leveraging member 46 is coupled to gripping member 44a at a third pivot point 48c at a location adjacent to and more central than the position of second pivot point 48b along gripping member 44a. The other end of leveraging member 46 is joined to a central location of first handle 42 at a fourth pivot point 48d.

Support structure 34 of first member 20 of press 10 includes a connection element 36 of a known type (e.g., a weld, braze, or mechanical element, such as one or more rivets or nuts and bolts) by which a position of first member 20 is fixed relative to an interior portion 43i of head 43. Second member 30 similarly includes a connection element 26 that couples substrate 21 of second member 30 to an interior portion 45i of head 45.

Of course, alternative embodiments of presses are also within the scope of the present invention. For example, a system according to the present invention may include a table-top press of the type that includes a hand-operated lever for causing a single biasing member to be moved against a back side 64 of a die 60, thereby forcing die 60 against a sheet of paper, card stock, or other material from which design or pattern 70 of die 60 is to be cut.

Referring now to FIG. 4, an example of the assembly of a die 60 with press 10 is depicted. Back side 64 of die 60 is oriented so as to oppose die receiving surface 22 of first member and positioned thereagainst. Die retaining element 24 engages die 60, securing the same in position against die receiving surface 22. Die 60 may subsequently be released by die retaining element 24 and removed from die receiving surface 22. Another die 60 may then be positioned on and secured to die receiving surface 22.

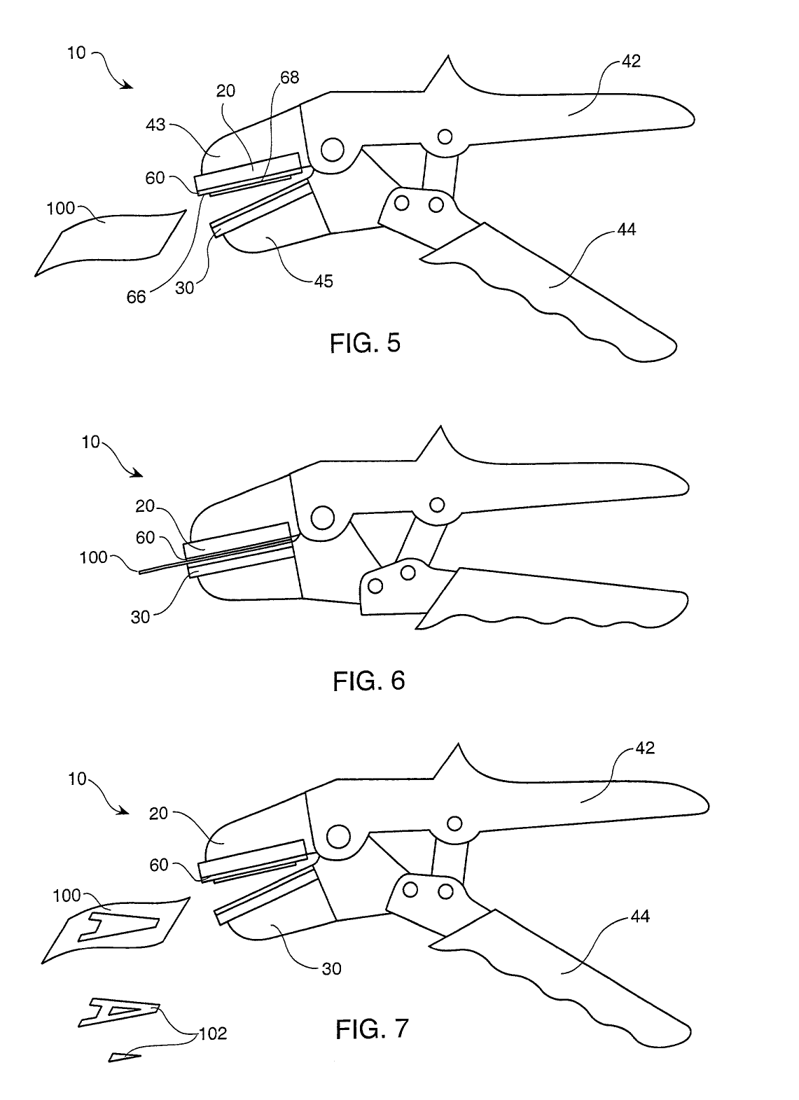

Turning now to FIGS. 5-7, an example of the use of press 10 and die 60 is illustrated.

As depicted in FIG. 5, once a die 60 has been assembled with press 10, one or more sheets 100 of paper, card stock, or another material may be positioned between front side 66 of die 60, which is secured to first member 20, and second member 30 of press 10. Handles 42 and 44 may then be moved toward one another, in turn forcing heads 43 and 45 and the respective first and second members 20 and 30 secured thereto toward one another.

When first member 20 and second member 30 are biased against one another with sufficient force, as shown in FIG. 6, each ejection element 72 (FIGS. 1 and 2) of die 60 (if any) is compressed and cutting edges 68 of die 60 (FIGS. 1 and 2) are forced against and penetrate sheet 100.

Next, as illustrated in FIG. 7, first member 20 and second member 30 are forced apart from one another by moving handles 42 and 44 apart from each other. As first member 20 and second member 30 move away from each other, one or more ejection elements 72 (FIGS. 1 and 2) of die 60 may resiliently expand, ejecting one or more die cuttings 102 from the confines of cutting edges 68. Die cuttings 102 and the remainder of sheet 100 may then be removed from between the first and second members 20 and 30. Press 10 and die 60 may then be used to form additional die cuttings 102, or die 60 may be removed from press 10 and another die 60 assembled therewith in place of the first die 60.

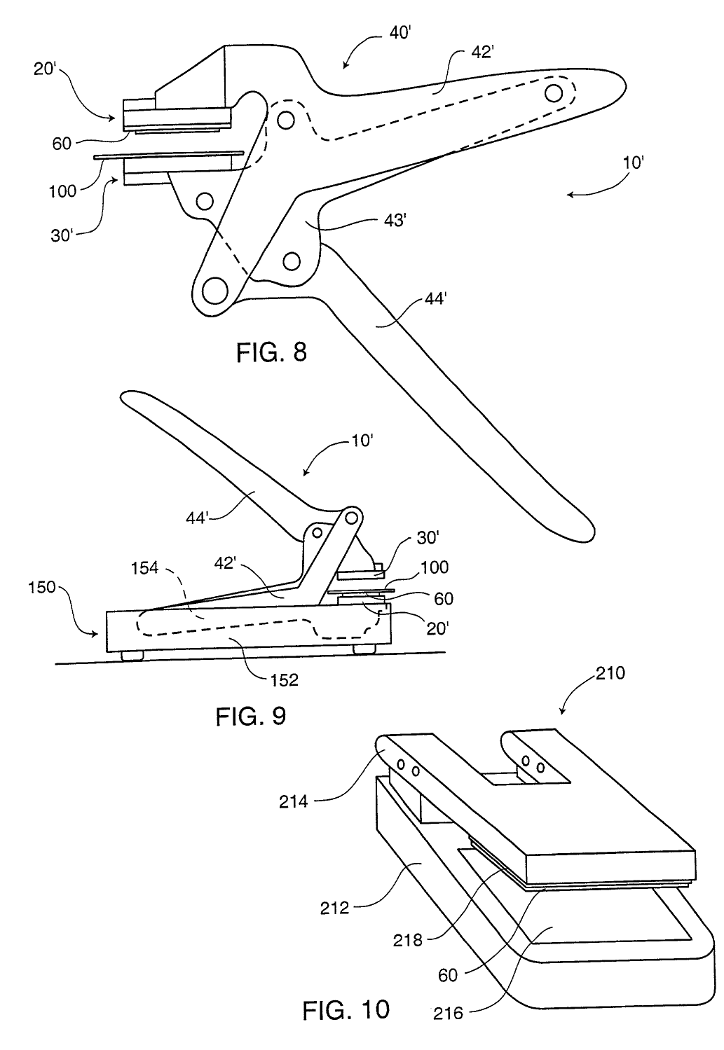

FIG. 8 illustrates another embodiment of hand-held press 10′ incorporating teachings of the present invention. Press 10′, which is configured to bias a die 60 against a sheet 100 of paper or other material in a direction that is substantially perpendicular to the sheet, includes a first member 20′ that receives and retains a die 60, a second member 30′ that supports a sheet 100, and a biasing element 40′ that facilitates movement of first and second members 20′ and 30′ toward and away from one another while maintaining a substantially parallel relation between first member 20′ and second member 30′. Biasing element 40′ includes handle members 42′ and 44′ and an intermediate member 43′ associated therewith that are configured and arranged to maintain the substantially parallel relation of first member 20′ and second member 30′ during movement thereof relative to one another. Such a biasing element 40′ may, for example, comprise the crimp system pliers that are available from Knipex as catalog no. 97 43 200 or those manufactured by Sargent Quality Tools and available as series 4100 and 4200 from Rostra Tool Company of Branford, Conn. Press 10′ may be used in a similar fashion to the use of press 10, as depicted in FIGS. 5-7 and described with reference thereto.

Turning now to FIG. 9, a hand-held press incorporating teachings of the present invention (e.g., presses 10 and 10′) may be supported upon a substantially flat surface, such as a tabletop, by way of a cradle element 150. As depicted in FIG. 9, cradle element 150 includes a base member 152 that is configured to be supported upon a substantially flat surface and an opposing receptacle 154 that receives at least a portion of handle 42′ (or handle 44′) of biasing element 40′ of press 10′. Receptacle 154 may also be configured to receive a portion of biasing element 40′ to which either first member 20′ or second member 30′ is secured, as well as a portion of first member 20′ or second member 30′.

Cradle element 150 retains first member 20′ (or second member 30′) of press 10′ in a substantially stationary position as handle 44′ is moved toward handle 42′ and, thus, as second member 30′ of press 10′ and first member 20′ thereof are forced toward one another. Thus, cradle element 150′ facilitates the application of pressure by die 60 and second member 30′ to a sheet 100 of paper or another material by way of a downward force rather than by way of the squeezing action that is required when cradle element 150 is not used with press 10′.

Yet another embodiment of press 210 that may be used with a die 60 of the present invention to form a pattern from a sheet of paper or another material is shown in FIG. 10. Press 210 includes a base 212 and a handle 214, or biasing element, that is pivotally associated with base 212.

Base 212 of press 210 is configured to be supported upon a substantially flat surface, such as a tabletop, and to remain in a substantially stationary position upon the substantially flat surface during use of press 210. Base 212 includes a sheet support surface 216 upon which a sheet 100 of paper or other material is held as press 210 is being used with a die 60 to cut into sheet 100.

A die support element 218, which is configured to detachably receive and retain a die 60 (e.g., as described above with reference to die retaining elements 24, 24′, 24″ depicted in and described with reference to FIGS. 3-3C or otherwise, as known in the art), is associated with handle 214 so as to facilitate the biasing of die 60 against sheet 100 upon movement of handle 214 toward base 212. Likewise, upon movement of handle 214 away from base 212, die support element 218 and, thus, a die 60 secured thereto, moves away from sheet support surface 216 and a sheet 100 of paper or other material positioned thereon.

Although the foregoing description contains many specifics, these should not be construed as limiting the scope of the present invention, but merely as providing illustrations of some exemplary embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

What is claimed is:

1. A die cutting system for forming patterns from a sheet of material, comprising:
a press including first and second members movable toward and away from one another, said first member including a die retaining element associated with a die receiving surface thereof, said second member including a sheet supporting surface oriented to oppose said die receiving surface; and
at least one die securable to said first member by said die retaining element, said die comprising a thin, unitary member including a substantially planar plate and at least one cutting edge protruding from a surface of said substantially planar plate.

2. The die cutting system of claim 1, wherein said press includes a biasing element for moving at least one of said first and second member toward the other of said first and second member.

3. The die cutting system of claim 2, wherein said biasing element includes a pair of pivotally connected handles.

4. The die cutting system of claim 2, wherein said biasing element includes a handle that moves relative to a substantially stationary base.

5. The die cutting system of claim 1, wherein said die retaining element comprises magnetic material.

6. The die cutting system of claim 5, wherein at least said plate comprises a material that is attracted to a magnetic field.

7. The die cutting system of claim 1, wherein said die comprises steel.

8. The die cutting system of claim 1, wherein said die retaining element mechanically secures said die to said die receiving surface.

9. The die cutting system of claim 1, wherein said sheet supporting surface of said second member comprises a cushioning element.

10. The die cutting system of claim 1, wherein said die further includes at least one ejection element between adjacent portions of said at least one cutting edge.

11. The die cutting system of claim 1, wherein said at least one ejection element is compressible and resilient.

12. An apparatus for forcing a die through a sheet of material, comprising:
a first member including:
a die receiving surface; and
a die retaining element associated with said die receiving surface, said die retaining element configured to receive a substantially planar die;
a second member including:
a substantially planar sheet supporting surface oriented to oppose said die receiving surface; and
a biasing element associated with at least one member of said first and second members so as to move said at least one member toward the other of said first and second members.

13. The apparatus of claim 12, wherein said die retaining element is magnetic.

14. The apparatus of claim 12, wherein said die retaining element mechanically secures a substantially planar die to said die receiving surface.

15. The apparatus of claim 12, wherein said second member includes a cushioning element that forms at least a portion of said substantially planar sheet supporting surface.

16. The apparatus of claim 12, wherein said biasing element is configured to be held by and operated with a hand of a user.

17. The apparatus of claim 12, wherein said biasing element comprises a handle moveable relative to a base member by which said second member is supported.

18. The apparatus of claim 17, wherein said base member is configured to be supported upon a substantially flat surface.

19. A method for forming a pattern from a sheet of material, comprising:
providing a substantially planar die including a plate and at least one cutting edge protruding therefrom; and
manually biasing said substantially planar die against the sheet and a substantially planar sheet supporting surface located opposite the sheet.

20. The method of claim 19, wherein said manually biasing comprises forcing a member carrying said substantially planar die toward said sheet and said substantially planar sheet supporting surface.

21. The method of claim 20, wherein said forcing includes applying force to at least one handle of a press associated with said member.

22. The method of claim 21, wherein said forcing comprises squeezing two handle members of a hand-held press toward one another.

23. The method of claim 20, further comprising securing said substantially planar die to said member.
